(19) United States
(12) Patent Application Publication
(10) Pub. No.: US 2014/0236742 A1
(43) Pub. Date: Aug. 21, 2014

(54) NETWORK ADVERTISING MANAGEMENT SYSTEM AND PROGRAM FOR NETWORK ADVERTISING MANAGEMENT SYSTEM

(71) Applicant: F@N Communications, Inc., Tokyo (JP)

(72) Inventor: Ryo Sakuma, Tokyo (JP)

(73) Assignee: F@N COMMUNICATIONS, INC., Tokyo (JP)

(21) Appl. No.: 14/349,223

(22) PCT Filed: Sep. 29, 2012
(86) PCT No.: PCT/JP2012/075267

§ 371 Date: Apr. 2, 2014

(30) Foreign Application Priority Data
Oct. 3, 2011 (JP) 2011-219100

(51) Int. Cl. G06Q 30/02

(52) U.S. Cl. CPC G06Q 30/0277
USPC 705/14.73

(57) ABSTRACT

Problems: To reduce a burden of publication of an application to advertising utilizing a media application.

Solution means: A media application in a user's terminal U is programmed with SDK (managing software on the user side). A link destination information is set to an advertising display to be displayed on the user's terminal U. By selecting an advertising display by the user's terminal U, access is made to an application store AS via a managing server MS. The managing server MS acquires an application information corresponding to the advertising display selected by the user's terminal U, a media application information in the user's terminal U, and information on the user's terminal U and stores them as first information. The user's terminal U delivers a newly installed application information and the user's terminal information to the managing server MS as second information on the basis of SDK, when the newly installed application was detected. The managing server MS specifies the media application contributed to the purchase of an application by collating the second information with the first information, when the second information was received.

### REFERENCE TO RELATED APPLICATIONS

This application is a national stage application under 35 USC 371 of International Application No. PCT/JP2012/075267, filed Sep. 29, 2012, which claims priority to Japanese application no. 2011-219100, filed Oct. 3, 2011, the entire contents of which are incorporated herein by reference.

### TECHNICAL FIELD

The present invention relates to a network advertising management system and a program for the network advertising management system.

### BACKGROUND ART

Recently, user's information terminals such as smart phones, etc. are spreading throughout, and the user's information terminals are installed with applications which are to be started up on the user's information terminals to enjoy contents of the applications (Patent Document 1). The applications are registered and accumulated in a downloading service site such as AppStore, Android Markets, etc., from which users may download their favorite applications to their own user's information terminals.

The applications providing the above contents are begun to be used for the adverting of other applications (hereinafter the application to be used for the advertising of other applications being referred to as “media application”). The advertising of other applications using the media application may be performed by publishing an applications list display in a contents display screen or on another screen to be opened by selection operation during the startup of the media application. In the event that a media application user who saw the applications list display (hereinafter referred to as “user”) selects the favorite published application display in the applications list display, contingency fees are paid to a developer or seller developing or selling the media applications for contribution by the media application, when the user's information terminal of the user makes access to the downloading service site via a mediation of the published application display (a link information to the downloading service site being embedded thereunder) and purchases (downloads or installs) the favorite published application published in the media application via the media application at the downloading service site.

Particularly, in the media application, upon advertising other applications, there is a tendency to adopt reward advertising. The reward advertising is an advertising service to provide an item of contents or a point in the media application, when a user enjoying contents of a media application purchases a published application published in the media application at the downloading service site through the media application. The reward advertising may give users the motivation to purchase the published applications published in the media application and promote the sales of the published applications.

In the advertising of the other applications utilizing the media application, the tracking processing of recording and tracking the user's action is performed to comprehend the media application through which the published application of the media application was purchased from the downloading service site (to effect the payment of contingency fees, etc.).

More specifically, upon making access to the downloading service site from the published application display in the media application, the access is made through a managing server managed by an advertising management company delivering the published applications information, through which the user's information terminal ID, the media application information, and the selected published applications information are collected by the managing server. Thereafter, procedures for purchasing the published application in the downloading service site are downloaded (including until installed) by the user's information terminal, the user's information terminal ID is delivered to the advertising managing server when the published application purchased was started up for the first time. By collating the user's information terminal ID to be delivered for the first time with the user's information terminal ID collected by the managing server upon making access to the downloading service site from the published applications publication display in the media application, the media application (developer or seller) of the media application contributed to the purchase of the published application is identified. This enables the exact payment of the contingency fees to the developer or seller of the media application contributed to the purchase of the published application and the provision of the media application user with the reward based on the reward advertising, resulting in the promotion of the reward advertising utilizing the media application.

### PRIOR ART REFERENCES

### Patent Documents

Patent Document 1: Japanese Patent Application Publication No. 2011-175,611

### SUMMARY OF THE INVENTION

### Problems to be Solved by the Invention

In the network advertising management system (tracking system), however, it is required to program a tracking software (tracking SDK (Software Development Kit)) in each of the published applications to be downloaded from the downloading service site in order to enable the delivery of the user's information terminal ID and the like to the managing server at the first startup. An advertiser of each published application is required to bear operational and financial burden for programming the tracking software.

Further, in the downloading service site, only the application that has passed an examination (an appropriateness examination of programs) is registered and accumulated, and the examination may take from one week to one month to the maximum. Moreover, the examination is made whenever updated. Therefore, an advertiser who publishes an application on the advertising utilizing the media application wishes to avoid the operation of programming the tracking software for the application to be published to the utmost. Therefore, the threshold is still too high to publish an application in the media application as advertising utilizing the media application.

The present invention has been performed with the above problems taken into consideration. The first technical problem is to provide a network advertising management system capable of reducing a burden of publication of an application to the advertising utilizing a media application.

The second technical problem is to provide a program for the network advertising management system to be applied to the network advertising management system.

### Means for Solving the Problems

In order to solve the first technical problem, the present invention (the invention as claimed in claim 1) adopts the following solution. In other words, a network advertising management system is structured in such a manner that the network advertising management system is connected to a downloading service site, a user's information terminal, and a managing server, the downloading service site holding a number of applications and providing a downloading service of the applications, the user's information terminal comprising a downloading means for downloading applications from the downloading service site, in which a media application for displaying an advertising display of contents and applications is installed, and the managing server which delivers the advertising display of applications held in the downloading service site to the media application of the user's information terminal, which exists independently from the downloading service site, and which is not provided with information for specifying the media application contributed to a purchase of the application from the downloading service site, to each other via a network,

wherein the user's information terminal comprises:

a first information delivery processing for delivering the selected advertising display information, a media application information in correspondence relation with the selected advertising display, and the user's information terminal information as first information to the downloading service site via the managing server, when the advertising display in correspondence with the media application is selected,

a newly installed application detection means for detecting a newly installed application, and,

a second information delivery means for delivering the newly installed application information and the user's information terminal information as second information to the managing server, when the newly installed application detection means decides the presence of the newly installed application,

wherein the managing server comprises:

a reception means receiving the first information and the second information,

a storage means storing the first information received by the reception means, and

a media application specifying means specifying the media application contributed to the purchase of an application by collating the second information with the first information stored by the storage means, when the second information is received by the reception means,

wherein the function of the newly installed application detection means and the function of the second information delivery means are executed on the basis of a managing software on the user side, which is programmed in the media application installed in the user's information terminal, and

wherein the first information is delivered to the downloading service site via the managing server on the basis of a link destination information set in the advertising display.

The preferred embodiments of claim 1 are described as described in claim 2.

In order to solve the second technical problem, the present invention (the invention according to claim 3) adopts the following solution. In other words, a program for the network advertising management system, characterized by the program for the network advertising management system to be used as a managing software to be installed in a media application under a network advertising management system connected through a network to a downloading service site, a user's information terminal, and a managing server, the user's information terminal, the downloading service site holding a number of applications and providing a downloading service of the applications, the user's information terminal comprising a downloading means for downloading applications from the downloading service site, in which a media application capable of displaying contents and an advertising display is installed, and the managing server which delivers the advertising display of the applications held in the downloading service site to the media application of the user's information terminal, which exists independently from the downloading service site and which is not provided with information for specifying the media application contributed to a purchase of an application,

wherein a computer of the user's information terminal with the media application installed therein executes:

newly installed application detection processing for detecting a newly installed application, and

associated information delivery processing for delivering the newly installed application information and the user's information terminal information to the managing server, when the presence of the newly installed application is decided on the basis of the processing result of the newly installed application detection processing.

Preferred embodiments of claim 4 will be as described in the claims following claim 4.

### Effects of the Invention

The present invention (the invention as described in claim 1) requires no installation of an application corresponding to the advertising display in the managing software on the user side because the media application contributed to the application sales can be specified solely by programming a managing software in the media application for browsing the advertising display. This can reduce a burden of publication of applications on the advertising utilizing the media application.

The present invention as described in claim 2 can exactly deliver the first information to the managing server upon making access to the downloading service site via the managing server from the user's information terminal, consequently resulting in reducing a burden on the side of a developer or seller of the media application, because the user's information terminal further comprises:

an advertising delivery request means for requesting the delivery of the advertising display of the application, and

an information setting means for setting the link destination information, the user's information terminal information, and the media application information to the advertising display of the application delivered on the basis of the request by the advertising delivery request means,

wherein the function of the advertising delivery request means and the function of the information setting means are executed on the basis of the managing server on the user side programmed in the media application installed in the user's information terminal.

The present invention (the invention as described in claim 3) can exactly provide the managing server with the information for the tracking processing (the second information) in the network advertising management system solely by programming the involved program in the media application even without programming a tracking software (program) in the application to be advertised in the media application. This can result in reducing the burden of an advertiser advertising an application in a media application.

The present invention as described in claim 4 can specifically realize the results achieved by the invention of claim 3 because the newly installed application detection processing executes:

retrieving processing for retrieving installed applications installed in the user's information terminal,

application list preparing processing for preparing an application list of the applications installed in the user's information terminal by updating the results of the retrieving processing in order, and

newly installed application retrieving processing for detecting an application not listed in the application list as a newly installed application by collating the results of the retrieving processing with the application list retrieved immediately before the retrieving processing, and

the associated information delivery processing executes processing of delivering the newly installed application information and the user's information terminal information to the managing server on the basis of the results of the newly installed application retrieving processing, when the presence of the newly installed application is decided.

The present invention as described in claim 5 can readily retrieve the installed applications in the user's information terminal, resulting in an easy retrieval of the newly installed application, because the computer of the user's information terminal executes a URL scheme request processing for making a request to the managing server for a URL scheme of the application to be displayed as advertising in the media application,

wherein the installed application retrieval programming executes the retrieval programming of the installed applications installed in the user's information terminal by utilizing the URL scheme obtained on the basis of the request by the URL scheme request processing.

The present invention as described in claim 6 enables an easy retrieval of the installed applications in the user's information terminal by the function of the user's information terminal on the basis of an operating software (OS (Android, etc.)), consequently resulting in an easy retrieval of the newly installed application, because the installed application retrieval programming is executed by the request for a list of the installed applications installed in the user's information terminal to the user's information terminal.

The present invention as described in claim 7 can exactly provide the managing server with the information for the tracking processing (first information) by the program in the network advertising management system, because the computer of the user's information terminal executes:

the advertising delivery request processing for making a request for the advertising display of the application to the managing server, and

the information setting processing for setting the link destination information for making access to the downloading service site via the managing server, the information on the application corresponding to the advertising display, the information on the media application corresponding to the advertising display installed in the user's information terminal, and the user's information terminal information to the advertising display of the application to be displayed on the user's information terminal by the media application.

### BRIEF DESCRIPTION OF THE ACCOMPANYING DRAWINGS

FIG. 1 is an explanation view showing a whole structure of a network advertising delivery management system as an embodiment of the present invention.

FIG. 2 is an explanatory view showing an internal structure of a user's terminal.

FIG. 3 is a view explaining a state in which a contents display to be displayed on a display screen of a user's terminal is switched to a publication list display of advertising applications.

FIG. 4 is an explanatory view explaining the retrieval of a newly installed application in the user's terminal and the delivery to the managing server of an associated information associated with the newly installed application.

FIG. 5 is a flowchart showing an example of controlling reward advertising in a user's terminal.

FIG. 6 is a flowchart to be continued from FIG. 5.

FIG. 7 is a flowchart indicating an example of controlling an advertising delivery in a managing server.

FIG. 8 is a flowchart indicating an example of controlling an acquisition of user's terminal ID, etc. (first information) by a managing server upon making access to an application store via the managing server by the user's terminal.

FIG. 9 is a flowchart indicating an example of controlling tracking processing (collation, etc.) after downloading/installing an application in the user's terminal by the managing server.

### MODES FOR CARRYING OUT THE INVENTION

The present invention will be described by way of examples with reference to the accompanying drawings.

1. Summary of Network Advertising Management System:

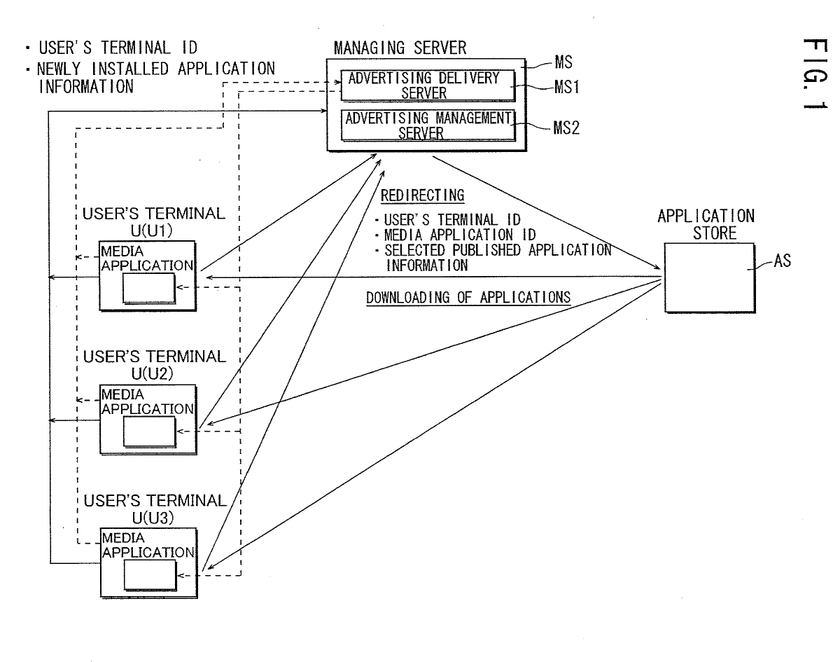

FIG. 1 is a view showing a whole structure of the network advertising management system according to a working embodiment of the present invention. In FIG. 1, reference symbols U1, U2, and U3 (collectively referred to as U) mean user's terminals, which are represented by a portion of many terminals, as user's information terminals. Reference symbol MS means a managing server managed and administered by an advertising management company and managing the advertising delivery to the user's terminals U1, U2, and U3, and other operations. Reference symbol AS means an application store as a downloading service site for selling applications to be used by the user's terminals U1, U2, and U3. The user's terminals U1, U2, and U3, the managing server MS, and the application store AS are communicated to each other by a network such as internet, etc., and a user may enjoy contents (games, etc.) of the application by downloading the application to the user's terminals U1, U2, and U3 from the application store AS. As a matter of course, the managing server MS exists independently from the application store AS and is not provided with the information specifying the media application contributed to the purchase of the application from the application store AS.

Among the applications installed in the user's terminals U1, U2, and U3, there is an application to be made subject to reward advertising by displaying a published application display of other applications to promote the sales of other applications by taking advantage of popularity of the application (hereinafter referred to as “media application”). The reward advertising is an advertising service providing items of the media application such as game software, etc. or points, when a published applications display is browsed on a display screen of the media application displayed by the user's terminals U1, U2, and U3 and the published application was purchased at the application store AS, resulting in tending to give the motivation to purchase a published application. Therefore, in the event that a media application user purchases a published application, the user may make access to the application store AS from the published application display in the media application and download the desired application in own user's terminals U1, U2, and U3.

In correspondence with this event, accordingly, the managing server MS of the advertising management company delivers reward advertising list display information (application publication list information, etc.) to the media application (user's terminal) in response to the request from the media application side (user's terminals U1, U2, and U3 side) (as shown in FIG. 1 by the broken-line arrow), and specifies the media application contributed to the sales of the published application by acquiring various information at various timings and collating these information. This permits the payment of contingency fees as contribution to the sales of the published application to the developer or seller of the media application and the provision of information on the purchaser of the published application in order to enable a reward to the purchase action as a contribution to the sales of the published application.

As a matter of course, upon making the reward advertising in the application (media application), an agreement regarding the advertising or the like will be in advance contracted among an application developer or seller desirous of making an application a media application, an advertiser of a published application desirous of having the reward advertising of an application in the media application, and an advertising management company.

2. Specific Contents of Network Advertising Management System

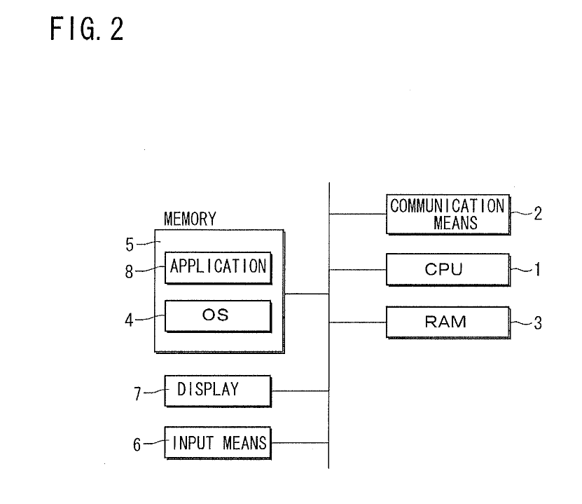

In this working embodiment, the user's terminals U1, U2, and U3, such as smart phones, etc., can install an application by downloading from outside and display the contents of the application. As shown in FIG. 2, the user's terminals U1, U2, and U3 are equipped each with elements of a computer consisting of a CPU 1 as an operation control means, a communication means 2, a RAM 3 storing data for executing various controls, an OS 4 for executing a basic operation of the CPU 1, a memory 5, an input means 6, a display 7, and so on.

As shown in FIG. 1, the user's terminals U1, U2, and U3 are installed each with a media application. The applications to be installed in the user's terminals U1, U2, and U3 may be basically downloaded from the application store AS on the basis of the purchasing action of a user. Whether the application is made subject to the reward advertising, i.e., whether it becomes a media application, is based on an agreement among the application developer or seller, the application advertiser desirous of publishing the application as the reward advertising, and the advertising management company. In this case, of course, the media application of the user's terminals U1, U2, and U3 may be identical to or different from each other, and the number may be different from each of the user's terminals U1, U2, and U3. For brevity of understanding, the following description will be made regarding one user's terminal (collectively represented by symbol “U”) representative of the user's terminals with one media application 8 installed therein.

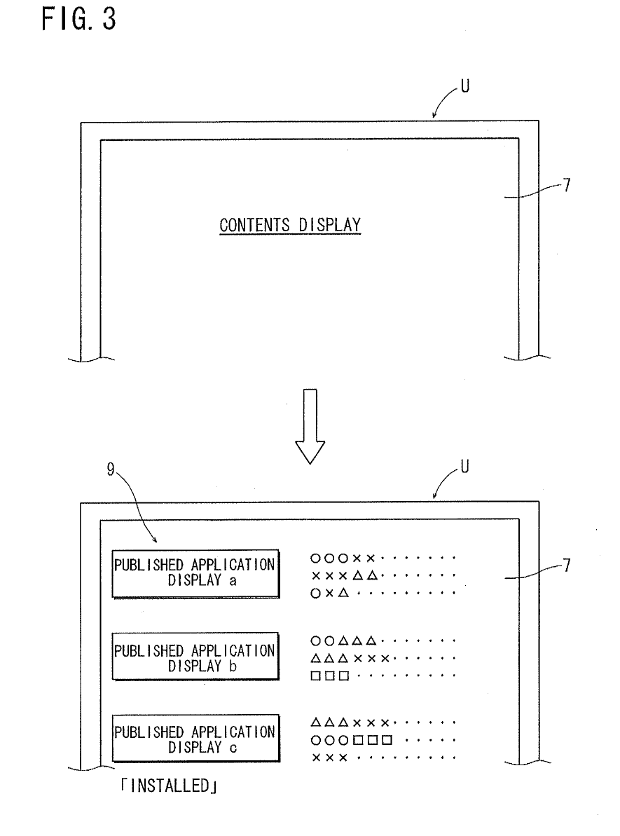

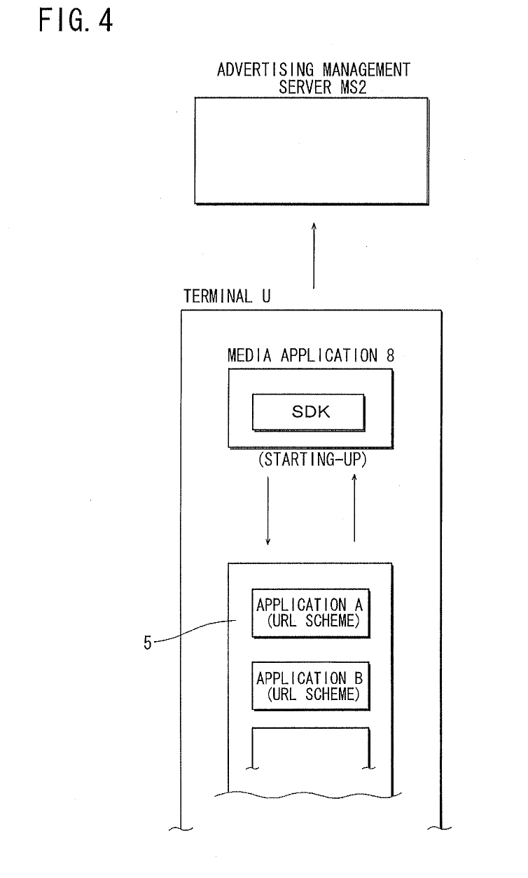

Like ordinary applications, the media application 8 installed in the user's terminal U is started up to operate the contents such as games, etc., thereby enabling to enjoy the contents (upper row of FIG. 3) and display the reward advertising list display 9 introducing other applications for reward advertising by the switch operation by the user (lower row of FIG. 3). Therefore, the media application 8 is in advance installed with a user-side managing software (commonly called SDK (Software Development Kit); hereinafter referred to as SDK) as one program of a media application on the basis of an agreement between the developer and seller and the advertising management company (see FIG. 4). In order to realize the above contents, the SDK (CPU 1) makes the user's terminal U execute the switch function between the above contents display and the reward advertising list display 9 (switch display), the function for determining a display site of each published application display in the reward advertising list display 9 within the media application 8, and the function for making a request to the managing server MS for a published application display information for displaying it as a published application display at each display site (function as the advertising delivery request means), and so on.

In this case, each of the published application displays a, b and c (refer to the lower row in FIG. 3) in the reward advertising list display 9 is embedded with a URL (a code containing a link destination) for making access (redirecting) to the application store AS via the managing server MS. Each URL is provided with the user's terminal ID, the media application ID, and the published application information on the published application display, etc., in Query String (a column of URL following the column marked by question mark (?)). This enables the managing server MS to acquire the user's terminal ID, the media application ID, the published application information, etc., selected by the user, at the time of redirecting. Of course, using other means, the user's terminal ID, the media application ID, the selected published application information and other information may be acquired by the managing server MS.

Moreover, in the event that the published application published on the reward advertising list display 9 is purchased at the application store AS via the media application 8, the SDK is set for the user's terminal U (CPU 1) to execute the function of delivering the newly installed published application information and the user's terminal ID to the managing server 8 (the function as the associated information delivery means; see FIG. 1), and to execute the functions (functions as the newly installed application detection means, the installed application retrieval means, the application list preparing means, and the newly installed application retrieval means; see FIG. 4) for retrieving (deciding) whether the newly published application is installed in the user's terminal U or not, by utilizing the function of making a request for the reward advertising list display information and the URL scheme of each published application (the function as a URL scheme request means) to the managing server MS, in order to specify the media application 8 contributed to the purchase of the published application (tracking processing).

In retrieving whether a published application is newly installed in the user's terminal U, as shown in FIG. 4, the SDK makes the user's terminal U retrieve the published application installed in the user's terminal U by the request for the URL scheme of each of the published applications and then determine whether the newly installed application exists or not by the comparison of the published application (installed application) installed at that point of time with the application list of the installed applications retrieved previously. In the retrieval utilizing the URL scheme, the characteristic of the URL scheme as to whether the application represented by the URL is installed in the user's terminal or not by designating an optional URL for the OS within the user's terminal from the SDK.

In this working embodiment, a description has been made regarding the case (e.g., the OS is iOS) in which the URL scheme has been used in the manner as described above in order to retrieve whether the published application is installed in the user's terminal U or not. In the event that a list of installed applications can be acquired as the function of an OS standard (e.g., the OS is Android), however, the user's terminal U can be used to decide whether a newly application is installed or not by the comparison of the then application list with the application list acquired beforehand, utilizing the application list. The SDK which makes the user's terminal U perform such processing is developed by an advertising management company. The tracking processing for specifying the media application 8 contributed to the purchase of the published application published in the reward advertising list 9 will be described in more detail hereinafter.

As shown in FIG. 1, the managing server MS is provided with an advertising delivery server MS1 and an advertising management server MS2. These servers are each equipped, as a matter of course, with all elements required for a computer. The advertising delivery server MS1 has functions for delivering information on the reward advertising list display 9 and the URL scheme of each of the published applications (displays a, b, and c) published in the reward advertising list display 9 to the advertising delivery request from the user's terminal U (SDK). The advertising management server MS2 has, for example, the function of acquiring and storing the user's terminal ID, the media application ID and the published application information (function as the acquisition storing means), when the user's terminal makes access to the application store AS via the published application displays a, b, and c in the reward advertising list display 9, and the function for specifying the media application 8 contributed to the purchase of the published application (the function as the media application specifying means), etc. on the basis of collation of the user's terminal ID to be delivered and the function for acquiring the newly installed application information (function as a reception means), when the user have purchased the published application at the application store AS after installing into the user's terminal U. As described above, this specifies the media application 8 as the object of payment of contingency fees and the user to be provided with the reward on the basis of the reward advertising.

As described above, the application store AS has a number of various applications to be used in the user's terminal U. The application store AS is provided with the function of delivering the application purchased (downloading function) to the user's terminal U when a purchase intention operation for the applications stored therein is performed from the user's terminal U (card payment). Among the applications held in the application store AS, the URL scheme is set each for the published applications published in the reward advertising list to be displayed on the user's terminal U on the basis of an agreement between an advertiser and advertising management company of the published applications. If the advertiser would have already set a URL scheme in the published applications optionally, the URL scheme can be used.

In the network advertising management system as described above, in the event that the media application 8 is installed in the user's terminal U, the user's terminal U makes access (redirects) to the application store AS through the managing server MS (advertising management server MS2) on the basis of the link destination information embedded in the published application display, when the reward advertising list display can be browsed during its startup and the published application in the reward advertising list display was touched (selected). Upon making access to the application store AS through the managing server MS, the user's terminal ID, the media application ID, the selected published application information, etc. are acquired by the advertising management server MS2 and stored as first information.

Thereafter, as the published application selected is purchased at the application store AS and downloaded/installed in own user's terminal U, by the action of the SDK, the user's terminal U retrieves the installed applications utilizing the URL scheme and then detects whether the newly installed application exists or not and, if it would exist, what kind of application exists on the basis of a collation of the installed application information and the application list information of the applications updated so far in order. Moreover, the user's terminal U delivers the newly installed application information and the user's terminal ID to the advertising management server MS2 as second information, when the newly installed application is decided to exist.

As the advertising management server MS2 receives the second information (i.e., the newly installed application information and the user's terminal ID) from the user's terminal U, it then specifies the media application contributed to the sales of the published application published in the reward advertising list by collating with the first information (i.e., the user's terminal ID, the media application ID, the selected published application information, etc.) acquired and stored upon making access via the managing server MS. This provides information on the purchaser of the published application (user information) in order to effect the payment of contingency fees to the media application developer or seller as contribution to the application sales and enable the provision of the purchasing action of the media application with a reward.

Therefore, in the network advertising management system, the media application contributed to the sales of the published applications can be specified in the manner as described above simply by programming the SDK in the media application 8 only, making it unnecessary to program a tracking software (e.g., a software delivering the user's terminal ID to the managing server MS from the user's terminal U at the first startup of the purchased application) in each published application to be published in the media application 8. This enables a remarkable reduction of the burden of publication of published applications on the reward advertising utilizing the media application, resulting in promotion of the publication (advertising) of applications to the media application 8.

In this case, although the SDK is programmed in the media application 8, the SDK is developed by the advertising management company so that the developer or seller desirous of making an application a media application may not bear any burden in this respect. Moreover, as the media application developer or seller is needed simply to perform operations similarly to conventional operations for programming SDK, the burden to perform programming operations is not increased.

3. Specific Examples of Control by Network Advertising Management System

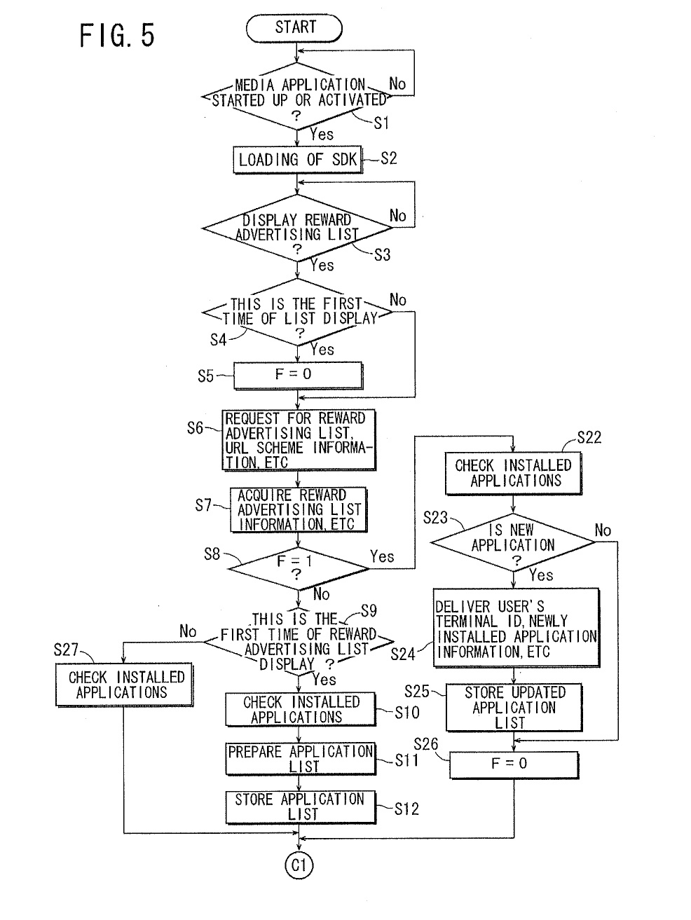

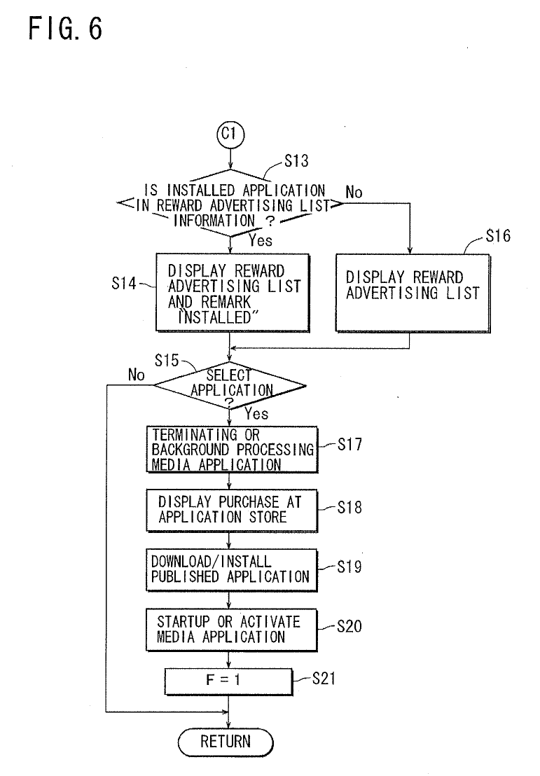

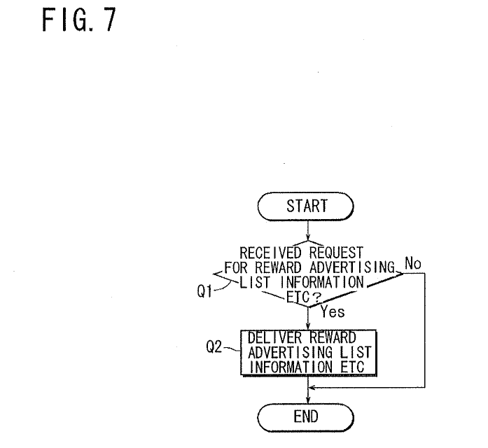

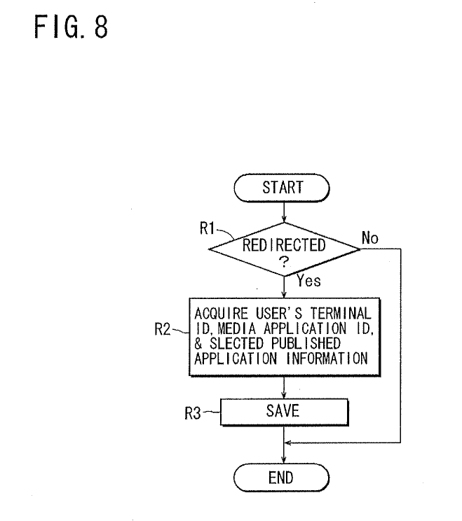

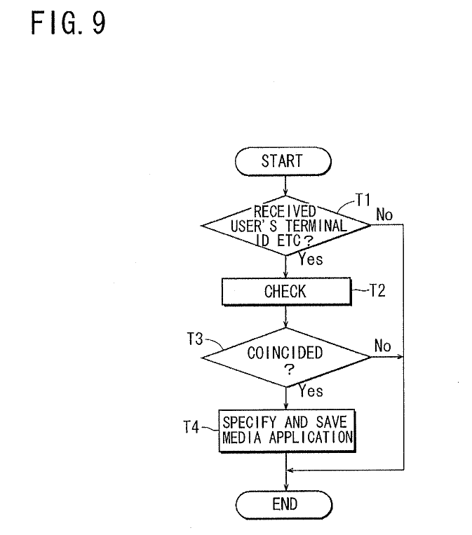

Next, system operations according to these above working embodiments will be specifically described with reference to the flowcharts as shown in FIGS. 5 to 9. Reference symbol S in FIG. 6, Q in FIG. 7, R in FIG. 8, and T in FIG. 9 represent each step. The user's terminal U is installed with the media application 8 which is in turn programmed with the SDK for executing advertising delivery, etc., including, for example, reward advertising list information, etc., for the object of advertising of a number of applications within applications, e.g., game software, etc., displaying ordinary contents.

First, as the media application 8 of the user's terminal U is started up or activated, the SDK programmed in the media application 8 is loaded (S1, S2). When the user then selects a selection display (not shown) of a reward advertising list in a contents display (e.g., game display) of the media application 8 on the display 7, the contents display is shifted to a reward advertising list display 9, as shown in FIG. 3. In the next step S4, it is decided whether the reward advertising list display 9 has been displayed for the first time in order to decide whether it is required for the first time to set the flag F to F=0. At the first time, the reward advertising list display 9 is first executed so that it is decided YES in S4, followed by going to S5 where the flag F is set to F=0. This flag F is to decide whether the tracking processing (execution of collation processing of the media application 8 through which the contribution to the sales of the published application published in the reward advertising list display 9) is terminated or not, after the termination of downloading/installing the application. When F=1, the status is shown that the tracking processing is not yet finished after the termination of downloading/installing the published application. When F=0, the status is shown that the published application is not yet downloaded/installed or the tracking processing has been finished after the termination of downloading/installing the published application. At the very beginning, no tracking processing is required so that, as shown in S5, the flag F is set to F=0, i.e., to the status that the published application is not downloaded/installed.

In next S6, the user's terminal U requires the reward advertising list display information and the URL scheme information of each published application shown in the reward advertising list display 9. As this request is made from the user's terminal U to the managing server MS (advertising management server MS2), the managing server MS delivers the reward advertising list display information, etc. to the user's terminal U in response to the request, and in S7, the user's terminal U acquires the reward advertising list display information and so on.

In this case, as shown in FIG. 7, in Q1, the managing server MS (advertising delivery server MS1) always decides whether the request for the reward advertising list display information, etc. is received or not. When the decision in Q1 is YES, then it is set to deliver the reward advertising list display information, etc. to the user's terminal U (referring to broken lines in FIG. 1).

In S7, the user's terminal U acquires the reward advertising list display information, etc., following to going to S8 where it is then decided whether the flag F is set to F=1 or not. Owing to the setting to F=0 at the very beginning, it is decided in S8 as NO, followed by going to S9 in which it is decided whether this reward advertising list display is displayed for the first time or not in order to decide whether it is required to newly prepare a reward advertising list display. At the very beginning, the reward advertising list display is displayed for the first time so that it is decided YES in S9, then followed by going to S10 in which it is checked as to what kind of the applications is installed in a memory of the user's terminal U.

In this working embodiment, the URL scheme is utilized for this checking. More specifically, the SDK in the user's terminal U gives a request to the user's terminal U for the URL scheme of each published application acquired in S7, deciding the presence or absence of installation of each published application. As the procedures for checking the applications installed in the memory of the user's terminal U, if a list of installed applications can be acquired (e.g., Android) as a standard function of the OS, it may be alternatively used.

In S10, when it is decided what kinds of applications are installed in the memory of the user's terminal U, then an application list is prepared in S11 and the contents are stored in the memory in S12, followed to going to next S13.

Then, in S13, it is decided whether the application indicated in the application list prepared in S11 exists in the information on the reward advertising list display acquired in S7. If S13 is YES, then the reward advertising list is displayed on the display screen of the user's terminal U in S14, as shown in the lower row in FIG. 3. At the same time, the published application display (published application display c in FIG. 3) of the application already installed in the user's terminal U is displayed “installed” as a remark, followed by going to S15. In this case, as an alternative embodiment of the published application display of the applications installed already in the user's terminal U, the published application display itself may not be displayed in S14.

On the other hand, when the decision in S13 is NO, as no published application has been already installed in the user's terminal U among the published applications of the reward advertising list display information, the reward advertising list display 9 is displayed without displaying the remark “installed” in S16, followed by going to next S15.

In S15, it is decided whether or not the published application display is selected from the reward advertising list display 9. If S15 is NO, the flow is returned. If S15 is YES, then the media application 8 is finished or subject to background processing, going to S18 where access is made to the application store AS and a purchase screen is displayed.

In this case, as shown in FIG. 8, the managing server MS (advertising management server MS2) always decides in R1 whether the access is redirected (i.e., access being made to the managing server MS on the way) on making access to the application store AS from the user's terminal U. If R1 is YES, then the flow goes to R2 where the managing server MS acquires the user's terminal ID, the media application ID, and the selected published application information. Then, in R3, they are stored as the first information in the storage means (not shown) of the managing server MS.

In S18, the purchase screen display of the application store AS is displayed, and then the flow goes to S19 where the downloading processing of the published application and the installing processing are performed via the purchasing procedures of the application selected in S15. As the processing is finished in S19, the flow goes to S20 where the media application 8 is started up or activated and then to S21 where the flag F is set to F=1, that is, to the status in which the downloading/installing of the application is finished, but the tracking processing is not yet finished, followed by returning the flow.

After returned as above, the flow again goes via S1 through S3 to S4 where the reward advertising list display 9 is decided whether its display is the first time or not. As this time is not the first time, the flow bypasses S5 and advances directly to S6, while the flag F is maintaining F=1. Thereafter, the flow advances via S7 to S8 where it is whether the flag F is F=1 or not. At this time, as it is maintained at F=1, S8 is decided YES, then the flow goes to S22 where it is checked what kind of application is installed in the memory of the user's terminal U. Then, in next S23, it is decided whether or not the newly installed published application has already been displayed by collating the installed applications checked in S22 with the applications in the published application list in S12.

If S23 is YES, the SDK allows the user's terminal U to deliver the user's terminal ID and the newly published application information to the managing server MS (advertising management serve MS2).

At this time, as shown in FIG. 9, the managing server MS always decides in T1 whether or not the user's terminal ID and the published application information were received in S24. If T1 is YES, then, in T2, the second information (the user's terminal ID and the published application information) received in S24 is collated with the first information (the user's terminal ID, the media application ID and the selected published application information, each acquired in accompaniment with redirecting in R2 (referring to FIG. 8). The flow then goes to T3 where it is decided whether or not there is the user's terminal ID and the published application information which coincide with each other. If T3 is YES, the user's terminal ID and the published application information in the second information coincide with those in the first information, the media application 8 is specified as the media application 8 contributed to the published application sales from the media application ID associated with the information coincided, and this information is stored for the payment of the contingency fees and the provision of the reward on the basis of the reward advertising. On the other hand, if the user's terminal ID, etc. are not received in T1 or if it is decided that nothing of the user's terminal ID and the published application information coincides between the first and second information in T3, the flow is returned.

In S25, the SDK of the user's terminal U updates the application list as latest published applications where the applications retrieved in S22 are installed and stores it in the storage means, when the user's terminal ID and the information on the published application newly installed in the user's terminal U are delivered to the managing server MS (advertising management server MS2) in S24, followed by going to S26. On the other hand, if S23 is NO, the flow advances directly to S26 without delivering the user's terminal ID, etc. to the managing server MS.

By the processing in S22 through S25, the tracking processing has been finished after the end of the downloading/installing of the application, followed by setting the flag F to F=0 in S26 and going to S13.

If the decision in S9 is NO, it is indicated that no application is downloaded (e.g., when S15 is NO) or the tracking processing has been finished after the end of the downloading/installing of the application, in addition to the display of the reward advertising list display 9 at the second time or et seq. At that time, in S27, the applications installed in the memory of the user's terminal U are checked, and the application detected by this checking is then decided whether or not it exists in the reward advertising list display information in S13.

It is to be noted herein that the objects of the present invention is not limited to those expressly described herein and are understood to encompass those which are described as being substantially preferred or corresponding to those described as advantageous.

### EXPLANATION OF REFERENCE SYMBOLS AND NUMERALS

U User's terminal
MS Managing server
MS2 Advertising management server
AS Application store
1 CPU
8 Media application
9 Reward advertising list display

1. A network advertising management systemt wherein:
the network advertising management system is connected to a downloading service site, a user's information terminal, and a managing server, the downloading service site holding a number of applications and providing a downloading service of the applications, the user's information terminal comprising a downloading means for downloading applications from the downloading service site, in which a media application for displaying an advertising display of contents and applications is installed, and the managing server which delivers the advertising display of applications held in the downloading service site to the media application of the user's information terminal, which exists independently from the downloading service site, and which is not provided with information for specifying the media application contributed to a purchase of the application from the downloading service site, to each other via a network,
wherein the user's information terminal comprises:
a first information delivery means for delivering the selected advertising display information, a media application information in correspondence relation with the selected advertising display and the user's information terminal information as first information to the downloading service site via the managing server, when the advertising display in correspondence with the media application is selected,
a newly installed application detection means for detecting a newly installed application, and
a second information delivery means for delivering the newly installed application information and the user's information terminal information as second information to the managing server, when the newly installed application detection means decides the presence of the newly installed application,
wherein the managing server comprises:
a reception means receiving the first information and the second information,
a storage means storing the first information received by the reception means, and
a media application specifying means specifying the media application contributed to the purchase of an application by collating the second information with the first information stored by the storage means, when the second information is received by the reception means,
wherein the function of the newly installed application detection means and the function of the second information delivery means are executed on the basis of a managing software on the user side which is programmed in the media application installed in the user's information terminal, and
wherein the first information is delivered to the downloading service site via the managing server on the basis of a link destination information set in the advertising display.

2. The network advertising management system as claimed in claim 1, wherein the user's information terminal comprises:
an advertising delivery request means for making a request for delivery of the application advertising display, and
an information setting means for setting the link destination information, the user's information terminal information, and a media application information to the advertising display delivered on the basis of the request of the advertising delivery request means,
wherein a function of the advertising delivery request means and a function of the information setting means are executed on the basis of the managing software on the user side programmed in the media application installed in the user's information terminal.

3. A program for a network advertising management system, wherein the program for the network advertising management system is used as a managing software to be installed in a media application under a network advertising management system connected through a network to a downloading service site, a user's information terminal, and a managing server, the downloading service site holding a number of applications and providing a downloading service of the applications, the user's information terminal comprising a downloading means for downloading applications from the downloading service site, in which a media application capable of displaying contents and an advertising display is installed, and the managing server which delivers the advertising display of the applications held in the downloading service site to the media application of the user's information terminal, which exists independently from the downloading service site and which is not provided with information for specifying the media application contributed to a purchase of an application,
wherein a computer of the user's information terminals installed with the media application executes a newly installed application detection processing for detecting a newly installed application and an associated information delivery processing for delivering the newly installed application information and the user's terminal information to the managing server on the basis of processing results of the newly installed application detection processing, when the newly installed application is decided to exist.

4. The program for the network advertising management system as claimed in claim 3, wherein the newly installed application detection processing executes:
installed application retrieving processing for retrieving an installed application installed in the user's information terminal,
application list preparing processing for preparing an application list of the applications installed in the user's information terminal by updating retrieving results of the installed application retrieving processing in order, and
newly installed application retrieving processing for detecting an application which does not exist in the application list by collating the retrieving results of the installed application retrieving processing with the application list immediately before the retrieval by the installed application retrieving processing,
wherein the associated information delivery processing executes processing for delivering the newly installed application information and the user's information terminal information to the managing server on the basis of the result of the newly installed application retrieving processing, when the presence of the newly installed application is decided.

5. The program for the network advertising management system as claimed in claim 4, wherein the computer of the user's information terminal executes a URL scheme request processing for making a request to the managing server for a URL scheme of an application to be displayed for advertising on the advertising display in the media application, and
the installed application retrieving processing executes the installed application retrieving processing installed in the user's information terminal utilizing the URL scheme received on the basis of the request by the URL scheme request processing.

6. The program for the network advertising management system as claimed in claim 4, wherein the installed application retrieving processing is executed by making a request for a list of applications installed in the user's information terminal to the user's information terminal.

7. The program for the network advertising management system as claimed in claim 3, wherein:
the computer of the user's information terminal executes advertising delivery request processing for requesting for the application advertising display to the managing server, and
information setting processing for setting link destination information for making access to the downloading service site via the managing server, the application information corresponding to the advertising display, the media application information installed in the user's information terminal and corresponding to the advertising display, and the user's information terminal information to the application advertising display for displaying the media application on the user's information terminal.
